(19) United States
(12) Patent Application Publication
(10) Pub. No.: US 2022/0069426 A1
(43) Pub. Date: Mar. 3, 2022

(54) FILTERS HAVING A MOVABLE RADIO FREQUENCY TRANSMISSION LINE

(71) Applicant: CommScope Italy S.R.L., Agrate Brianza (IT)

(72) Inventors: Roman Tkadlec, Valasske Klobouky (CZ); Marco Riva, Monticello Brianza (LC) (IT)

(21) Appl. No.: 17/341,578

(22) Filed: Jun. 8, 2021

(30) Foreign Application Priority Data
Aug. 31, 2020 (IT) 102020000020752
Oct. 29, 2020 (IT) 102020000025753

(51) Int. Cl. H01P 1/207; H01P 7/06; H01P 1/10

(52) U.S. Cl. CPC H01P 1/207; H01P 1/10; H01P 7/065

(57) ABSTRACT

Filter devices that include a movable radio frequency (RF) transmission line are provided. A filter device that includes a movable RF transmission line also includes a plurality of resonators. The movable RF transmission line is configured to move between a first position and a second position relative to the resonators. Electromagnetic coupling between the movable RF transmission line and the resonators is reduced at the second position relative to the first position. Related methods of operating filter devices are also provided.

### CROSS-REFERENCE TO RELATED APPLICATIONS

The present application claims priority to Italian Patent Application Nos. 102020000020752, filed Aug. 31, 2020, and 102020000025753, filed Oct. 29, 2020, the entire content of each of which is incorporated herein by reference.

### FIELD

The present disclosure relates to communications systems and, in particular, to radio frequency (“RF”) filters.

### BACKGROUND

Base station antennas for wireless communications systems are used to provide cellular communications service to fixed and mobile users that are within defined coverage areas of the respective base station antennas. These base station antennas typically include one or more linear arrays or two-dimensional arrays of radiating elements, such as dipole, or crossed-dipole, radiating elements that act as individual antenna elements. Each of these arrays may be connected to one or more RF ports. The RF ports are used to pass RF signals between the arrays and one or more radios.

Example base station antennas are discussed in International Publication No. WO 2017/165512 to Bisiules, U.S. patent application Ser. No. 15/921,694 to Bisiules et al., and U.S. Patent Application No. 63/024,846 to Hamdy et al., the disclosures of which are hereby incorporated herein by reference in their entireties. Though it may be advantageous for a base station antenna to use an RF filter for a particular application of the antenna, use of the filter may be undesirable for another application (e.g., a different mode) of the antenna.

### SUMMARY

A filter device, according to embodiments of the present inventive concepts, may include a housing. The filter device may include a plurality of resonators that are inside the housing. The filter device may include an RF signal input and an RF signal output. The filter device may include a movable RF transmission line that is coupled between the RF signal input and the RF signal output. The filter device may include an actuator that is configured to move the movable RF transmission line between a first position that is inside the housing and a second position that is inside the housing. Moreover, the resonators may be electromagnetically coupled to the movable RF transmission line when the movable RF transmission line is at the first position and may be electromagnetically decoupled from the movable RF transmission line when the movable RF transmission line is at the second position.

In some embodiments, the movable RF transmission line may be a first movable RF transmission line and the resonators may be first resonators. The filter device may include a plurality of second resonators that are inside the housing. Moreover, the filter device may include a second movable RF transmission line that is configured to move between a third position at which the second movable RF transmission line is electromagnetically coupled to the second resonators and a fourth position at which the second movable RF transmission line is electromagnetically decoupled from the second resonators.

According to some embodiments, the filter device may include a plurality of third resonators that are inside the housing. The filter device may include a third movable RF transmission line that is configured to move between a fifth position at which the third movable RF transmission line is electromagnetically coupled to the third resonators and a sixth position at which the third movable RF transmission line is electromagnetically decoupled from the third resonators. The filter device may include a plurality of fourth resonators that are inside the housing. Moreover, the filter device may include a fourth movable RF transmission line that is configured to move between a seventh position at which the fourth movable RF transmission line is electromagnetically coupled to the fourth resonators and an eighth position at which the fourth movable RF transmission line is electromagnetically decoupled from the fourth resonators.

In some embodiments, filter device may include a dielectric rod that is coupled between the actuator and each of the first through fourth movable RF transmission lines. Moreover, the filter device may include a spring that is coupled between the dielectric rod and the actuator, and the actuator may be a solenoid or an electric motor.

According to some embodiments, the first through fourth movable RF transmission lines may be in first through fourth slots, respectively, of the housing.

In some embodiments, the movable RF transmission line may be between opposite first and second interior sidewalls of the housing. Moreover, the resonators may be in respective cavities in the first interior sidewall.

According to some embodiments, the resonators may be first resonators that are configured to provide a first filtering response. The filter device may include a plurality of second resonators that are configured to provide a second filtering response that is different from the first filtering response. Moreover, the second resonators may be in respective cavities in the second interior sidewall.

In some embodiments, the actuator may be configured to move the movable RF transmission line between the first position and the second position by bending the movable RF transmission line. In other embodiments, the filter device may include a spring that is coupled to an end portion of the movable RF transmission line, and the actuator may be configured to move the movable RF transmission line between the first position and the second position by applying a mechanical force to the movable RF transmission line that bends the spring.

According to some embodiments, the resonators may be first resonators that are configured to provide a first filtering response. The filter device may include a plurality of second resonators that are configured to provide a second filtering response that is different from the first filtering response. Moreover, the movable RF transmission line may be closer to the first resonators than the second resonators at the first position and may be closer to the second resonators than the first resonators at the second position.

In some embodiments, the actuator may be a remotely-controllable actuator. Moreover, the filter device may include a port that is coupled to the remotely-controllable actuator, and the port and the remotely-controllable actuator may be a remote electrical tilt (RET) port and a RET actuator, respectively.

According to some embodiments, the filter device may be configured to operate in a first filtering-response mode when the movable RF transmission line is at the first position and to operate in a second filtering-response mode when the movable RF transmission line is at the second position. Moreover, the second filtering-response mode may have a wider passband than the first filtering-response mode.

In some embodiments, the movable RF transmission line may be a bi-stable transmission line.

A filter device, according to embodiments of the present inventive concepts, may include a plurality of resonators. The filter device may include first and second RF ports. The filter device may include a movable RF transmission line that is coupled between the first RF port and the second RF port. Moreover, the filter device may include an actuator that is configured to move the movable RF transmission line between a first position at which the movable RF transmission line is electromagnetically coupled to the resonators and a second position at which the movable RF transmission line is electromagnetically decoupled from the resonators.

In some embodiments, the filter device may include a spring-loaded rod that is coupled between the actuator and the movable RF transmission line.

A filter device, according to embodiments of the present inventive concepts, may include a plurality of resonators. Moreover, the filter device may include a movable RF transmission line that is configured to move between a first position and a second position relative to the resonators. Electromagnetic coupling between the movable RF transmission line and the resonators may be reduced at the second position relative to the first position.

In some embodiments, the movable RF transmission line may be a bi-stable transmission line.

According to some embodiments, the movable RF transmission line may be a first of a plurality of movable RF transmission lines. Moreover, the filter device may include a dielectric rod that is coupled to, and configured to concurrently move, each of the movable RF transmission lines.

In some embodiments, the movable RF transmission line may include a plurality of flexible arc portions that are each configured to invert.

A method of operating a filter device of a base station antenna, according to embodiments of the present inventive concepts, may include switching between first and second filtering-response modes of the filter device by moving a movable RF transmission line of the filter device, in response to a signal that originates from outside of the base station antenna to remotely control the filter device.

In some embodiments, moving the movable RF transmission line may include reducing electromagnetic coupling between the movable RF transmission line and a plurality of resonators of the filter device.

According to some embodiments, moving the movable RF transmission line may include applying a mechanical force to the movable RF transmission line. Applying the mechanical force may include using an actuator to move a dielectric rod that is coupled to the movable RF transmission line. For example, moving the dielectric rod may include bending the movable RF transmission line. As another example, moving the dielectric rod may include bending a spring that is coupled to an end portion of the movable RF transmission line.

In some embodiments, the signal may include an Antenna Interface Standards Group (“AISG”) command.

According to some embodiments, the second filtering-response mode may use a wider passband than the first filtering-response mode.

In some embodiments, the movable RF transmission line may be a first among a plurality of movable RF transmission lines of the filter device. Moreover, moving the movable RF transmission line may include concurrently moving each of the movable RF transmission lines.

A filter device, according to embodiments of the present inventive concepts, may include a plurality of resonators. The filter device may include a movable RF transmission line including a plurality of arc portions that are each configured to move relative to the resonators. Moreover, the filter device may include a plurality of supports that are connected to respective boundary regions between adjacent ones of the arc portions.

In some embodiments, the supports may include respective openings that are configured to receive the movable RF transmission line. Moreover, the supports may be configured to maintain a generally sinusoidal shape of the movable RF transmission line.

According to some embodiments, the supports may be configured to axially rotate. For example, the filter device may include an actuator that is configured to concurrently rotate non-consecutive ones of the supports. Moreover, the filter device may include a plurality of rotatable elements that are coupled between the non-consecutive ones of the supports, respectively, and the actuator.

### BRIEF DESCRIPTION OF THE DRAWINGS

FIG. 1A is a front perspective view of a base station antenna, according to embodiments of the present inventive concepts.

FIG. 1B is a front perspective view of the base station antenna of FIG. 1A electrically connected to a radio.

FIGS. 1C and 1D are schematic block diagrams of four-filter and eight-filter RF filter devices, respectively, according to embodiments of the present inventive concepts.

FIG. 1E is a schematic block diagram of ports of the base station antenna of FIG. 1A electrically connected to ports of the radio of FIG. 1B.

FIG. 2 is an example schematic front view of the base station antenna of FIG. 1A with the radome removed.

FIGS. 3A and 3B are top perspective views of the inside of the RF filter device of FIG. 1C during respective filtering-response modes.

FIG. 3C is an enlarged portion of the RF filter device of FIG. 3A.

FIGS. 4A and 4B are schematic top views of a slot of an RF filter device during respective filtering-response modes according to embodiments of the present inventive concepts.

FIGS. 5A-5D are top perspective views illustrating a sequence of bending a movable RF transmission line, according to embodiments of the present inventive concepts.

FIG. 6 is a schematic top view of a slot of an RF filter device having resonators on opposite sidewalls of the slot, according to embodiments of the present inventive concepts.

FIG. 7 is a flowchart illustrating operations of switching a filtering-response mode of an RF filter device, according to embodiments of the present inventive concepts.

FIGS. 8A and 8B are top views, during respective filtering-response modes, of the inside of an RF filter device including a movable RF transmission line that has multiple arc portions, according to embodiments of the present inventive concepts.

FIG. 8C is a top perspective view of the inside of the RF filter device of FIG. 8A.

FIG. 8D is a side perspective view of the movable RF transmission line of FIG. 8B.

FIG. 8E is a side perspective view of a support of FIG. 8C.

FIG. 8F is a top perspective view of a system that is configured to concurrently move each of the arc portions of FIG. 8D.

FIG. 8G is a top view of some of the supports of FIG. 8C.

FIG. 8H is a top view of the system of FIG. 8F.

### DETAILED DESCRIPTION

Pursuant to embodiments of the present inventive concepts, RF filter devices are provided that include one or more movable RF transmission lines. It may be desirable to provide two or more different filtering responses for an RF filter device that is integrated into a base station antenna or that is external to the antenna and interposed along RF paths between radio(s) and the antenna. In particular, having the flexibility to remotely switch between different filtering responses as new frequencies become available for use over time can be valuable. For example, frequencies that are initially used for satellite applications may become available for cellular base station antenna applications.

One conventional technique for switching between different filters is to perform the switching manually while a base station (e.g., at least one radio thereof) is powered off. Specifically, a technician can climb an antenna tower and manually swap an old filter with a new filter that is adapted for new frequencies. Remote switching, by contrast, can eliminate difficult manual work and may require little or no time for the base station to be powered off. Remote switching can thus reduce the cost of deploying a new filtering response for new frequencies.

Some conventional remote switching techniques, however, such as the use of electromechanical switches, may not be ideal for base station antenna applications. For example, though electromechanical switches may be used to switch between different filters of a filter bank, such electromechanical switches are typically high-power rated switches that are expensive and bulky. Moreover, electromechanical switches may introduce additional insertion losses and may not be suitable for applications requiring low passive intermodulation (“PIM”) distortion.

According to the present inventive concepts, however, a movable RF transmission line can be remotely controlled to move inside an RF filter device. Specifically, a mechanical force may be applied by an actuator to the transmission line to switch between different positions of the transmission line. In some embodiments, the transmission line may be a bi-stable transmission line that the force bends to transition the transmission line between two different stable positions thereof. In other embodiments, the transmission line may be a rigid transmission line that the force moves as springs coupled thereto bend.

An RF filter comprising the transmission line may be a notch-type filter having a plurality of resonators that are electromagnetically coupled to the transmission line when the transmission line is at a first position. A filtering response of the RF filter can be changed by moving the transmission line to a different, second position to electromagnetically decouple the transmission line from the resonators. For example, the second position may be adjacent a metal sidewall that is devoid of resonators therein. As another example, the second position may be adjacent a different plurality of resonators that are configured to provide a different filtering response from the resonators to which the transmission line was previously coupled.

Accordingly, a filtering response can be switched by applying a mechanical force that moves the transmission line. The transmission line can thus act as a switch. In some embodiments, movement of the transmission line may be controlled by a remote electrical tilt (“RET”) actuator, which may operate based on AISG commands. Moreover, the actuator may be coupled to the transmission line via a plastic rod/shaft that pushes/pulls the transmission line between its different positions. A plurality of movable RF transmission lines of respective RF filters can, in some embodiments, be coupled to (and thus concurrently moved by) the same rod/shaft inside a single RF filter device/unit. Various RF filter devices according to the present inventive concepts can therefore switch between different filtering responses by moving one or more transmission lines.

Example embodiments of the present inventive concepts will be described in greater detail with reference to the attached figures.

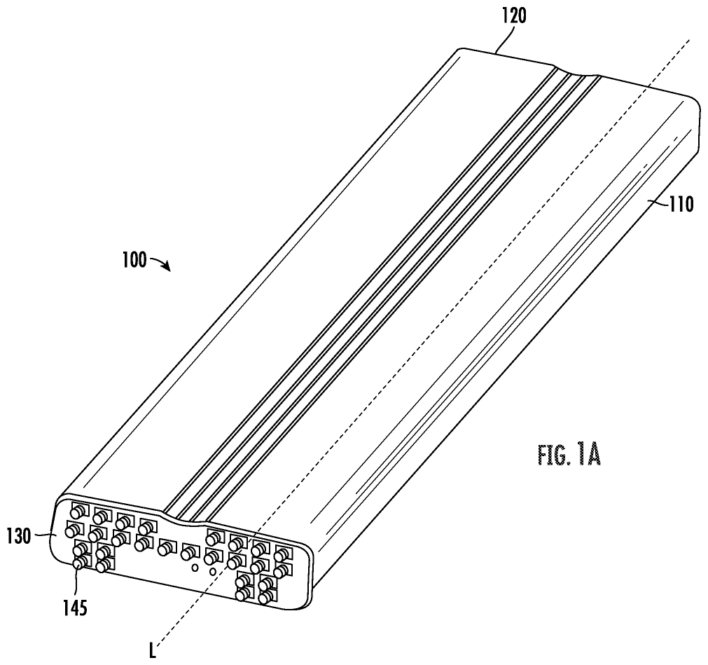

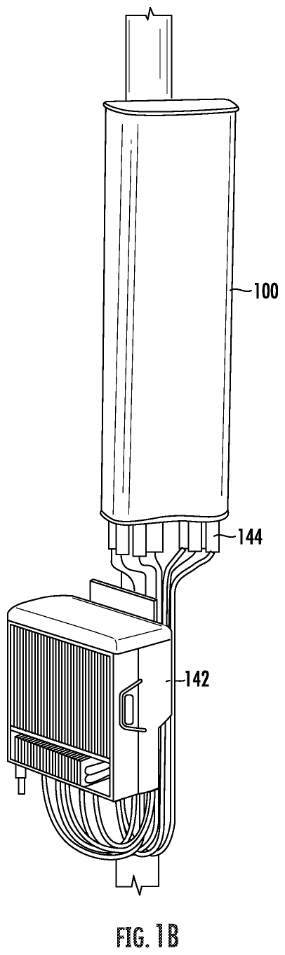

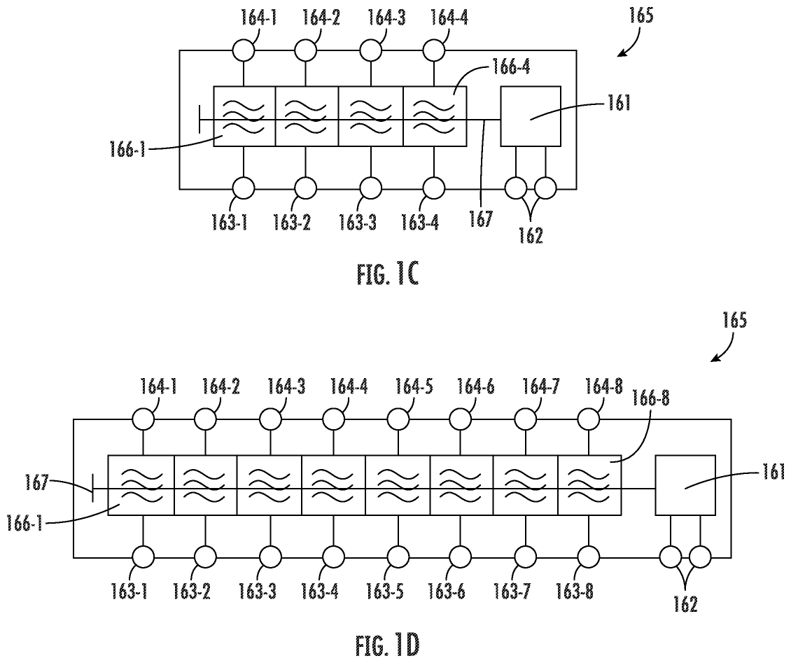

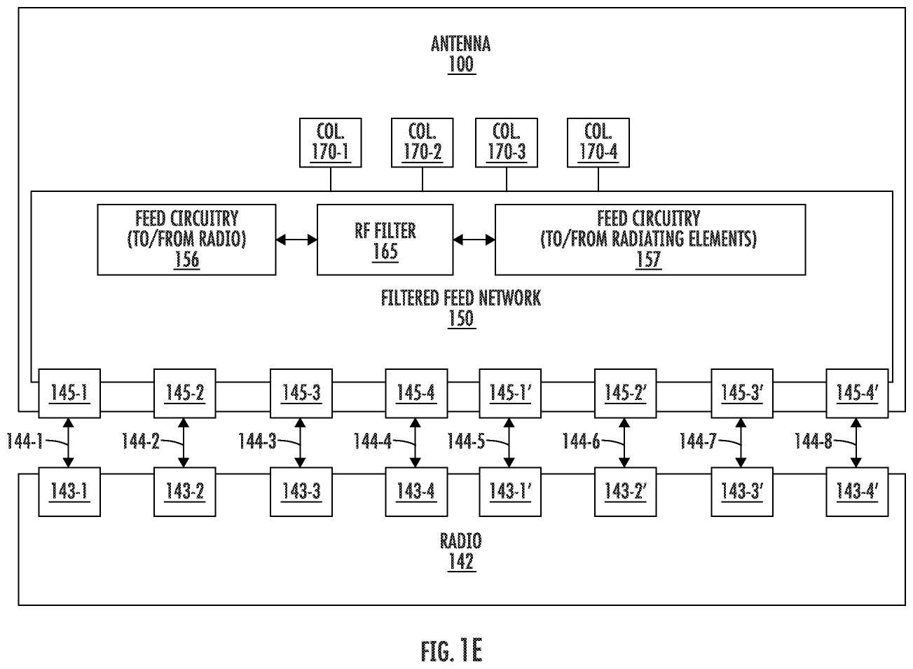

FIG. 1A is a front perspective view of a base station antenna 100, according to embodiments of the present inventive concepts. The antenna 100 may be, for example, a cellular base station antenna at a macrocell base station or at a small cell base station. As shown in FIG. 1A, the antenna 100 is an elongated structure and has a generally rectangular shape. The antenna 100 includes a radome 110. In some embodiments, the antenna 100 further includes a top end cap 120 and/or a bottom end cap 130. The bottom end cap 130 may include a plurality of RF connectors 145 mounted therein. The connectors 145, which may also be referred to herein as “ports,” are not limited, however, to being located on the bottom end cap 130. Rather, one or more of the connectors 145 may be provided on, for example, the rear (i.e., back) side of the radome 110 that is opposite the front side of the radome 110. The antenna 100 is typically mounted in a vertical configuration (i.e., the long side of the antenna 100 extends along a vertical axis L with respect to Earth).

FIG. 1B is a front perspective view of the base station antenna 100 electrically connected to a radio 142 by RF transmission lines 144, such as coaxial cables. For example, the radio 142 may be a cellular base station radio, and the antenna 100 and the radio 142 may be located at (e.g., may be components of) a cellular base station.

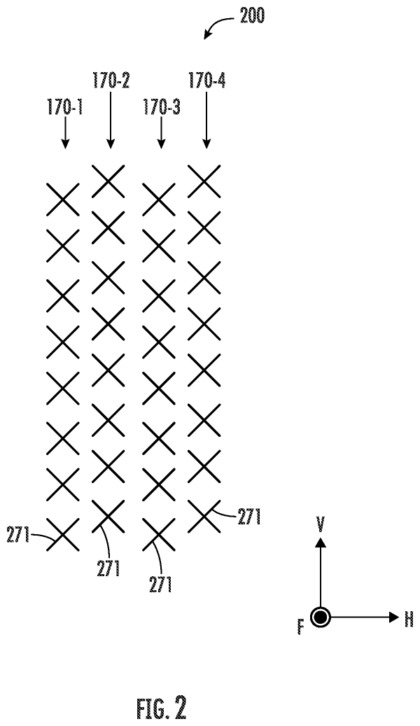

FIGS. 1C and 1D are schematic block diagrams of four-filter and eight-filter RF filter devices 165, respectively, according to embodiments of the present inventive concepts. The filter device 165 of FIG. 1C includes four RF filters 166-1 through 166-4 that can be coupled to a 4T4R radio, whereas the filter device 165 of FIG. 1D includes eight RF filters 166-1 through 166-8 that can be coupled to an 8T8R radio. Each filter 166 is coupled between a respective pair of RF ports 163 and 164 of the filter device 165. As an example, the filter 166-1 is coupled between a port 163-1 and a port 164-1. The ports 163 may be coupled to, for example, a radio 142 (FIG. 1B), and the ports 164 may be coupled to arrays 170 (FIG. 1E) of radiating elements 271 (FIG. 2) of a base station antenna 100 (FIG. 1A).

In some embodiments, the ports 163 may be RF signal input ports that provide downlink RF signals from the radio 142 to the filters 166, and the ports 164 may be RF signal output ports that provide filtered downlink RF signals that are output from the filters 166 to radiating elements 271 of the antenna 100. The ports 163 and the ports 164 may not be limited, however, to inputting and outputting, respectively, downlink RF signals. Rather, the ports 164 may serve as RF signal input ports that provide uplink RF signals from the radiating elements 271 to the filters 166, and the ports 163 may likewise serve as RF signal output ports that provide filtered uplink RF signals that are output from the filters 166 to the radio 142. Accordingly, the ports 163 and the ports 164 may be respective bidirectional ports that are coupled to the radio 142 and the arrays 170, respectively.

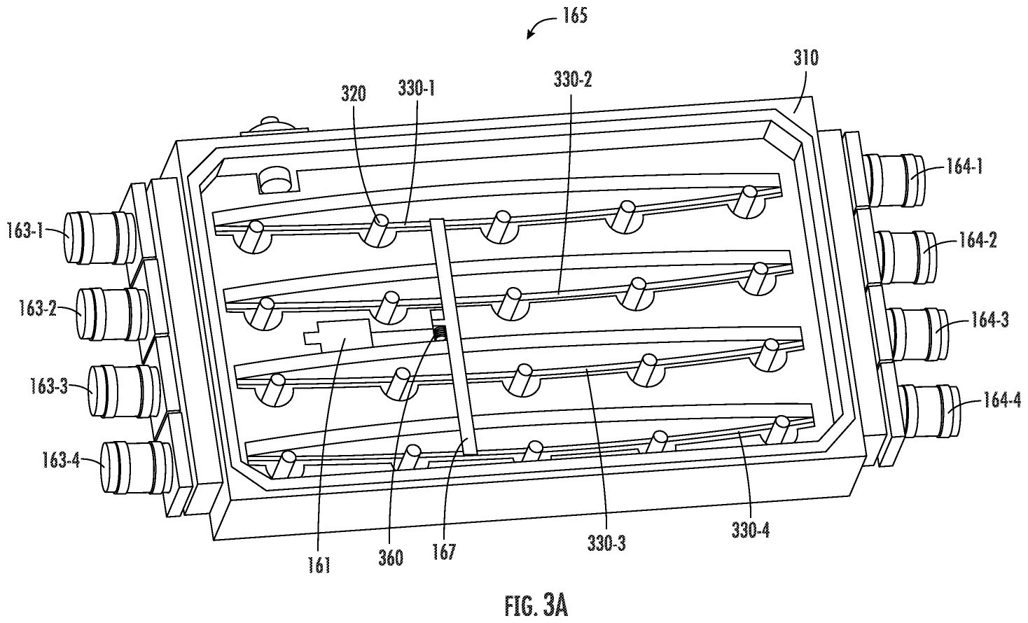

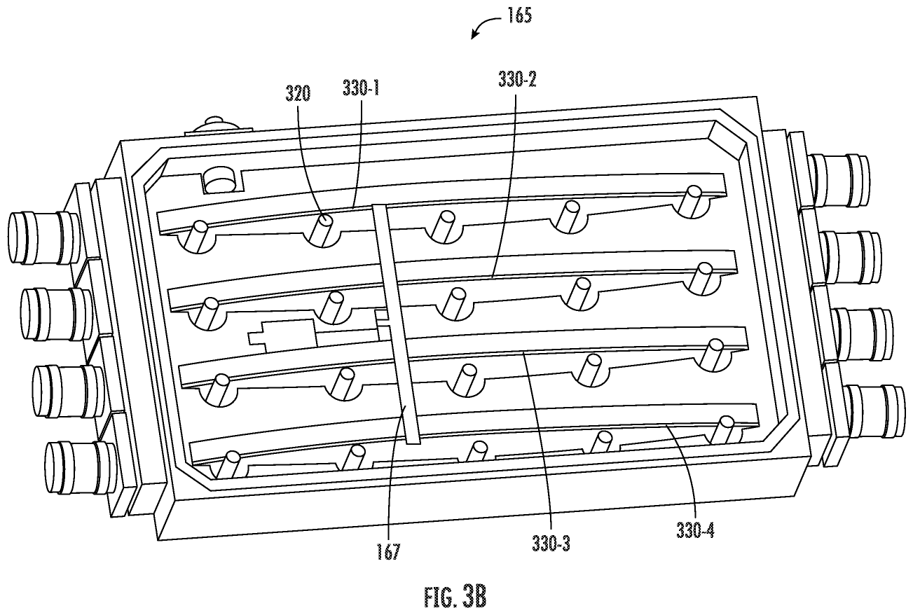

Each filter device 165 also includes an actuator 161 that is configured to move respective movable RF transmission lines 330 (FIG. 3A) of the filters 166, such as by moving a dielectric rod (or shaft) 167 that is physically connected (e.g., attached) to each of the transmission lines 330. The actuator 161 may be, for example, a solenoid or an electric motor. Moreover, the actuator 161 may be a remotely-controllable actuator, such as a RET actuator, and thus may include one or more RET ports 162. As an example, the ports 162 may include one input port and one output port. In some embodiments, a plurality of filter devices 165 may be daisy-chained with each other by connecting an output port 162 of a first actuator 161 of a first filter device 165 to an input port 162 of a second actuator 161 of a second filter device 165.

The filter device 165 may be a pole-mountable or wall-mountable outdoor unit that has a relatively small size and weight. For example, even if the filter device 165 includes eight filters 166, the filter device 165 may weigh less than 10 kilograms and have dimensions of no more than 270 millimeters (“mm”) in length by 150 mm in width by 90 mm in height. As an example, the dimensions may be no more than 180 mm by 80 mm by 70 mm. If the filter device 165 has only four filters 166, then the dimensions may be no more than 270 mm by 150 mm by 45 mm, or even no more than 180 mm by 80 mm by 40 mm. The filter device 165 may be configured to handle at least 40 Watts of RF power.

FIG. 1E is a schematic block diagram of ports 145 of the base station antenna 100 electrically connected to respective ports 143 of the radio 142. As shown in FIG. 1E, ports 145-1 through 145-4 of the antenna 100 are electrically connected to ports 143-1 through 143-4, respectively, of the radio 142 by respective RF transmission lines 144-1 through 144-4, such as coaxial cables. Similarly, ports 145-1′ through 145-4′ of the antenna 100 are electrically connected to ports 143-1′ through 143-4′, respectively, of the radio 142 by respective RF transmission lines 144-5 through 144-8. The ports 145-1 through 145-4 may transmit and/or receive RF signals in the same frequency band as the ports 145-1′ through 145-4′, or in a different frequency band from the ports 145-1′ through 145-4′. For simplicity of illustration, only eight ports 145 are shown in FIG. 1E. In some embodiments, however, the antenna 100 may include twelve, twenty, thirty, or more ports 145. Moreover, though all of the ports 143 are shown as being part of a single radio 142, it will be appreciated that the ports 143 may alternatively be spread across multiple radios 142.

The antenna 100 may transmit and/or receive RF signals in one or more frequency bands, such as one or more bands comprising frequencies between 3,550 megahertz (“MHz”) and 4,200 MHz. For example, the antenna 100 may transmit and/or receive RF signals in three or more different bands, including a first band comprising frequencies between 3,550 MHz and 3,700 MHz, a second band comprising frequencies between 3,700 MHz and 4,000 MHz, and a third band comprising frequencies between 4,000 MHz and 4,200 MHz. Moreover, the antenna 100 may, in some embodiments, transmit and/or receive RF signals in a portion of one of those bands, such as a first portion comprising frequencies between 3,700 MHz and 3,800 MHz, while rejecting RF signals in another portion, such as a second portion comprising frequencies between 3,820 MHz and 3,980 MHz.

The antenna 100 may include arrays (e.g., vertical columns) 170-1 through 170-4 of radiating elements 271 (FIG. 2) that are configured to transmit and/or receive RF signals. The antenna 100 may also include a filtered feed network 150 that is coupled between the arrays 170 and the radio 142. For example, the arrays 170 may be coupled to respective RF transmission paths (e.g., including one or more RF transmission lines) of the feed network 150.

In some embodiments, the feed network 150 may include one or more RF filter devices 165. Feed circuitry 156 of the feed network 150 may be coupled between each filter device 165 and the radio 142. In other embodiments, the filter device(s) 165 may be external to the antenna 100. As an example, a standalone unit that is coupled between the radio 142 and the antenna 100 may comprise the filter device(s) 165.

The feed network 150 may also include feed circuitry 157 that is coupled between the filter device(s) 165 and the arrays 170. The circuitry 156/157 can couple downlink RF signals from the radio 142 to radiating elements 271 that are in arrays 170. The circuitry 156/157 may also couple uplink RF signals from radiating elements 271 that are in arrays 170 to the radio 142. For example, the circuitry 156/157 may include power dividers, RF switches, RF couplers, and/or RF transmission lines that couple the filter device(s) 165 between the radio 142 and the arrays 170.

Moreover, the antenna 100 may include phase shifters that are used to electronically adjust the tilt angle of the antenna beams generated by each array 170. The phase shifters may be located at any appropriate location along the RF transmission paths that extend between the ports 145 and the arrays 170. Accordingly, though omitted from view in FIG. 1E for simplicity of illustration, the feed network 150 may include phase shifters.

FIG. 2 is an example schematic front view of the base station antenna 100 of FIG. 1A with the radome 110 thereof removed to illustrate an antenna assembly of the antenna 100. The antenna assembly includes a plurality of radiating elements 271, which may be grouped into one or more arrays 170.

For example, FIG. 2 shows an antenna assembly 200 including four arrays 170-1 through 170-4 of radiating elements 271 in four vertical columns, respectively, that are spaced apart from each other in a horizontal direction H. Vertical columns of radiating elements 271 may extend in a vertical direction V from a lower portion of the antenna assembly 200 to an upper portion of the antenna assembly 200. The vertical direction V may be, or may be parallel with, the longitudinal axis L (FIG. 1A). The vertical direction V may also be perpendicular to the horizontal direction H and a forward direction F. As used herein, the term “vertical” does not necessarily require that something is exactly vertical (e.g., the antenna 100 may have a small mechanical down-tilt). For simplicity of illustration, the feed circuitry 157 (FIG. 1E) that is coupled to the antenna assembly 200 is omitted from view in FIG. 2.

The arrays 170 are each configured to transmit and/or receive RF signals in one or more frequency bands, such as one or more bands comprising frequencies between 3,550 MHz and 4,200 MHz. Though FIG. 2 illustrates four arrays 170-1 through 170-4, the antenna assembly 200 may include more (e.g., five, six, or more) or fewer (e.g., three, two, or one) arrays 170. Moreover, the number of radiating elements 271 in an array 170 can be any quantity from two to twenty or more. For example, the four arrays 170-1 through 170-4 shown in FIG. 2 may each have five to twenty radiating elements 271. In some embodiments, the arrays 170 may each have the same number (e.g., eight) of radiating elements 271.

FIGS. 3A and 3B are top perspective views of the inside of the RF filter device 165 of FIG. 1C during respective filtering-response modes of the filter device 165. In particular, FIG. 3A illustrates a first filtering-response mode in which movable RF transmission lines 330 each have a first position at which they are electromagnetically coupled to respective groups of resonators 320 that are inside a housing 310 of the filter device 165. The transmission lines 330 may be, for example, respective suspended 50-Ohm (or other impedance) transmission lines, and the housing 310 may be a conductive (e.g., metal) housing. In the first filtering-response mode, the resonators 320 may be tuned to reject frequencies in a particular band.

FIG. 3B illustrates a second filtering-response mode in which the transmission lines 330 each have a second position at which they may be electromagnetically decoupled from the respective groups of resonators 320. In the second filtering-response mode, the transmission lines 330 may pass frequencies that are rejected in the first filtering-response mode. The second filtering-response mode may thus have a wider passband than the first filtering-response mode. For example, a passband of 3.7-3.8 gigahertz (“GHz”) may be widened to 3.7-3.98 GHz. As a result, a wider frequency band can be used by an array 170 (FIG. 1E) of radiating elements 271 (FIG. 2) and a radio 142 (FIG. 1E) that are coupled to the filter device 165.

As used herein, the term “electromagnetically coupled” may refer to one or more types of electromagnetic coupling. For example, electromagnetic coupling may include a combination of both capacitive coupling and inductive coupling. As another example, electromagnetic coupling may include only capacitive coupling or only inductive coupling. Moreover, the term “electromagnetically decoupled,” as used herein, may refer to a reduced level of electromagnetic coupling that results from increasing the distance between a transmission line 330 and a group of resonators 320. The reduced level may be a level of zero (or almost zero) electromagnetic coupling.

The group of resonators 320 may also be detuned while electromagnetically decoupled from the transmission line 330. In some embodiments, the resonators 320 may be mechanically detuned by movement of the transmission line 330 away from the resonators 320. Moreover, the filter device 165 may include a respective varactor that is coupled to each resonator 320 to electronically detune the resonators 320.

Switching between the first and second positions of the transmission lines 330 can be controlled by, for example, an actuator 161, which can move a dielectric (e.g., plastic) rod 167 that is attached to each of the transmission lines 330. Specifically, the rod 167 may be spring-loaded by a spring 360 that is coupled between the actuator 161 and the rod 167. Accordingly, the actuator 161 can move the rod 167 by causing the spring 360 to compress or relax. As a result of movement of the rod 167, the transmission lines 330 can move from their first position to their second position, or vice versa. This movement of the transmission lines 330 causes the filter device 165 to switch between its first and second filtering-response modes.

FIGS. 3A and 3B illustrate four transmission lines 330-1 through 330-4, which can be included in four RF filters 166-1 through 166-4 (FIG. 1C), respectively. The filter device 165, however, is not limited to four transmission lines 330. Rather, the filter device 165 may have, for example, eight or more transmission lines 330. As an example, the filter device 165 may include eight RF filters 166-1 through 166-8 (FIG. 1D), each of which has a respective transmission line 330 whose movement can be controlled by the actuator 161.

As shown in FIG. 3A, each transmission line 330 is coupled between a respective port 163 and a respective port 164. In some embodiments, the ports 163 and 164 may comprise connectors, such as 4.3-10 screw-in female connectors, that are attached to exterior sidewalls of the housing 310.

The filter device 165 may, in some embodiments, be integrated into a base station antenna 100 (FIG. 1A), such as in a feed network 150 (FIG. 1E) thereof. In other embodiments, the filter device 165 may be external to the antenna 100. For example, the filter device 165 may be mounted on a base station antenna tower. As an example, a standalone unit that is coupled between a radio 142 (FIG. 1B) and the antenna 100 may comprise the filter device 165.

In some embodiments, the filter device 165 may provide a notch filter for rejection of particular frequencies. The first filtering-response mode (FIG. 3A) and the second filtering-response mode (FIG. 3B) of the filter device 165 may thus be “in-service” and “out-of-service” modes, respectively. For example, in the in-service mode, the filter device 165 may be configured to provide at least 30 decibels (“dB”) of rejection, such as to block frequencies between 3.82 GHz and 3.86 GHz. The filter device 165 may be further configured to provide at least 40 dB of rejection in the in-service mode, such as to block frequencies between 3.86 GHz and 3.87 GHz. Moreover, the filter device 165 may be configured to provide at least 50 dB of rejection in the in-service mode, such as to block frequencies between 3.87 GHz and 3.98 GHz. Conversely, in the out-of-service mode, the filter device 165 may provide no more than 0.3 dB of insertion loss for frequencies between 3.82 GHz and 3.98 GHz or a portion thereof.

By providing both the in-service mode and the out-of-service mode, out-of-band spurious emissions (e.g., as generated by a 5G cellular radio, such as the radio 142) may be reduced during a certain period of time. In some embodiments, a default mode of the filter device 165 may be the in-service mode when the filter device 165 is installed. The mode can subsequently be changed to the out-of-service mode in response to receiving an AISG command (or a custom command) via a port 162 (FIG. 1C) of the filter device 165.

FIG. 3C is an enlarged portion of the RF filter device 165 of FIG. 3A. Each transmission line 330 of the filter device 165 may be in a respective slot 330S of the housing 310 (FIG. 3A). For example, as shown in FIG. 3C, the transmission line 330-4 may be in a slot 330S that is defined by opposite first and second interior sidewalls 322-1 and 322-2 of the housing 310. Accordingly, the transmission line 330-4 is between the sidewalls 322-1 and 322-2. In some embodiments, the sidewalls 322-1 and 322-2 may be metal sidewalls. Moreover, a plurality of resonators 320 may be in respective cavities 321 that are in the sidewall 322-1. Though FIG. 3C illustrates five resonators 320-1 through 320-5 in cavities 321-1 through 321-5, respectively, the sidewall 322-1 is not limited to having five resonators 320 therein. Rather, more (e.g., six or more) or fewer (e.g., four or fewer) resonators 320 may be in respective cavities 321 in the sidewall 322-1. Each cavity 321 may, in some embodiments, have dimensions of no more than 18 mm in length by 18 mm in width by 18 mm in height.

FIG. 3C further illustrates that the rod 167 is attached to a portion of the transmission line 330-4 that is between a pair of resonators 320-2 and 320-3. In some embodiments, however, the rod 167 may be attached to a different portion of the transmission line 330-4 that is between a different pair of resonators 320. For example, the rod 167 may be attached to a portion of the transmission line 330-4 that is between the resonators 320-3 and 320-4.

At the position shown in FIG. 3C, the transmission line 330-4 may be spaced apart from the resonators 320-1 through 320-5 by a relatively short distance. In particular, the transmission line 330-4 is shown as being closer to the sidewall 322-1 than to the opposite sidewall 322-2. Accordingly, electromagnetic coupling between the transmission line 330-4 and the resonators 320-1 through 320-5 may be relatively strong. By using the rod 167 to move the transmission line 330-4 to the position shown in FIG. 3B, however, electromagnetic coupling between the transmission line 330-4 and the resonators 320-1 through 320-5 may be relatively weak because the transmission line 330-4 is spaced apart from most (or all) of the resonators 320-1 through 320-5 by a relatively long distance. Specifically, the transmission line 330-4 (e.g., more than half of the total length thereof) may be closer to the sidewall 322-2 than to the sidewall 322-1.

Each of the transmission lines 330-1 through 330-4 may be movable between (i) a position that is relatively close to a respective plurality of resonators 320 and (ii) a different position that is farther from more than half (or all) of those resonators 320. For convenience of description, resonators 320 that share a first slot 330S with the transmission line 330-1 may be referred to herein as “first resonators,” resonators 320 that share a second slot 330S with the transmission line 330-2 may be referred to herein as “second resonators,” resonators 320 that share a third slot 330S with the transmission line 330-3 may be referred to herein as “third resonators,” and resonators 320 that share a fourth slot 330S with the transmission line 330-4 may be referred to herein as “fourth resonators.” Because the rod 167 may be attached to each of the transmission lines 330-1 through 330-4, the rod 167 can concurrently move all of the transmission lines 330-1 through 330-4 relative to the first through fourth resonators 320, respectively.

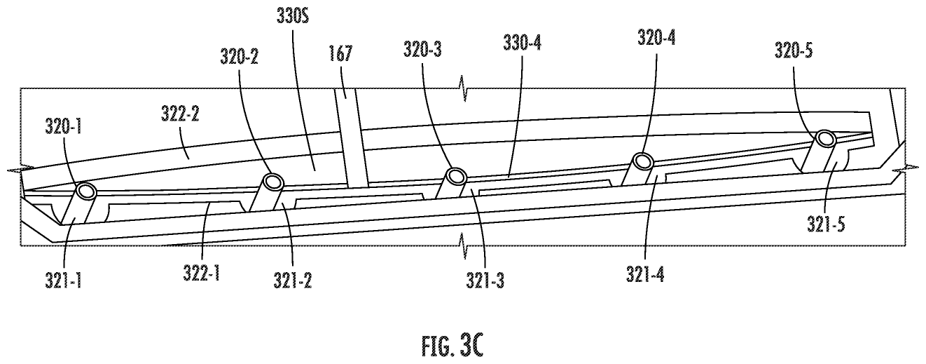

FIGS. 4A and 4B are schematic top views of a slot 330S of an RF filter device 165 (FIG. 3A) during respective filtering-response modes according to embodiments of the present inventive concepts. During a first filtering-response mode shown in FIG. 4A, a movable RF transmission line 330 is adjacent and electromagnetically coupled to a plurality of resonators 320 that are in respective cavities 321 in an interior sidewall 322-1 of the filter device 165. During a second filtering-response mode shown in FIG. 4B, the transmission line 330 is moved farther away, and thus electromagnetically decoupled, from the resonators 320. In particular, the transmission line 330 may be moved between (i) a first position (FIG. 4A) at which the transmission line 330 is closer to the sidewall 322-1 than to an opposite interior sidewall 322-2 and (ii) a second position (FIG. 4B) at which the transmission line 330 is closer to the sidewall 322-2 than to the sidewall 322-1.

The transmission line 330 can be moved between its first and second positions by bending one or more springs 410 that are coupled to end portions of the transmission line 330. For example, the transmission line 330 may be a rigid transmission line having first and second springs 410-1 and 410-2 that are coupled between (i) respective end portions of the rigid transmission line and (ii) respective ports 163 and 164. As an example, the spring 410-1 may be a first elastic metal strip that is soldered at one end to the port 163 and at an opposite end to a first end of the transmission line 330, and the spring 410-2 may be a second elastic metal strip that is soldered at one end to the port 164 and at an opposite end to a second end of the transmission line 330. Accordingly, an actuator 161 (FIG. 1C) may be configured to move the transmission line 330 by bending the springs 410-1 and 410-2 toward one of the sidewalls 322-1 and 322-2.

For simplicity of illustration, only one slot 330S is shown in FIGS. 4A and 4B. In some embodiments, however, the filter device 165 may include a plurality of (e.g., four, eight, or more) slots 330S, each of which has a respective transmission line 330 therein that is movable by bending one or more springs 410. Though a dielectric rod 167 (FIG. 3A) is omitted from view in FIGS. 4A and 4B for simplicity of illustration, the rod 167 may be attached to each transmission line 330. Accordingly, a mechanical force that is applied by the actuator 161 may move the rod 167 and thus the transmission lines 330. Because springs 410 are attached to end portions of the transmission lines 330, the springs 410 (rather than the transmission lines 330) can bend as the transmission lines 330 move.

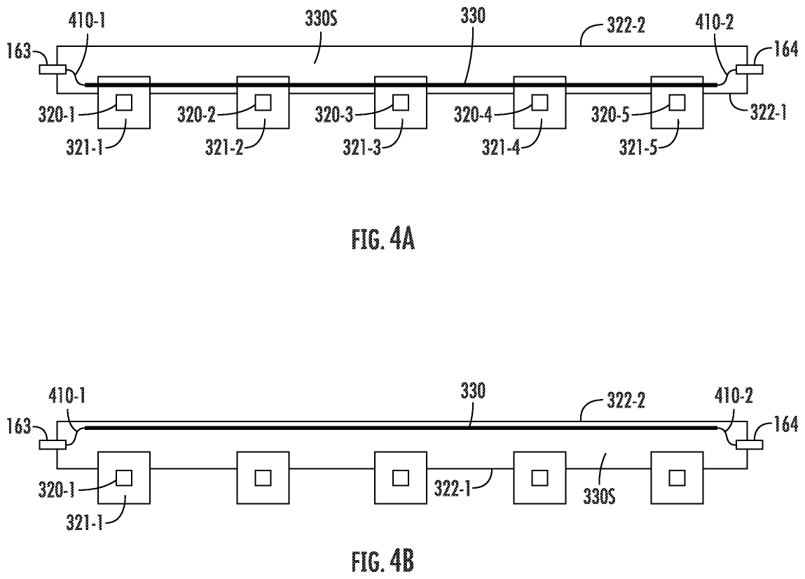

FIGS. 5A-5D are top perspective views illustrating a sequence of bending a movable RF transmission line 330, according to embodiments of the present inventive concepts. Accordingly, the transmission line 330 may, in some embodiments, be a flexible (rather than rigid) transmission line. For example, the transmission line 330 may comprise an elastic metal strip having opposite ends that are soldered to a port 163 (FIG. 3A) and a port 164 (FIG. 3A), respectively. Moreover, the transmission line 330 may be a bi-stable transmission line, which means that it has two stable positions.

A first of the stable positions is shown in FIG. 5B and a second of the stable positions is shown in FIG. 5D. The first of the stable positions may be obtained by compressing 510 the transmission line 330, as shown in FIG. 5A. The second of the stable positions may be obtained by applying a mechanical force to bend the transmission line 330 until the transmission line 330 snaps-through 520 to an opposite curvature, as shown in FIGS. 5B-5D. The force may be applied by an actuator 161 (FIG. 3A) via a dielectric rod 167 (FIG. 3A) that is coupled between the transmission line 330 and the actuator 161 while the transmission line 330 is in a slot 330S (FIG. 3C). The transmission line 330 may curve toward adjacent resonators 320 (FIG. 3A) of the slot 330S when it is in the first of the stable positions and may curve away from the resonators 320 (FIG. 3B) when it is in the second of the stable positions. Accordingly, moving the transmission line 330 to the second of the stable positions may electromagnetically decouple the transmission line 330 from the resonators 320.

In some embodiments, bending the transmission line 330 until it snaps-through 520 may irreversibly hold the transmission line 330 in the second of the stable positions, as the actuator 161 may not be sufficiently powerful to bend the transmission line 330 back to the first of the stable positions. Accordingly, the actuator 161 may provide a one-time (i.e., single-use) switch. In other embodiments, the transmission line 330 may be reversibly moved from the first of the stable positions to the second of the stable positions, as the actuator 161 may be configured to apply a sufficient force to reverse the snap-through 520.

The stable positions are positions at which the transmission line 330 can remain at rest (e.g., maintain its shape) without having a force applied thereto. An unstable position, by contrast, is a position at which the transmission line 330 must have a force continuously applied thereto to maintain that position.

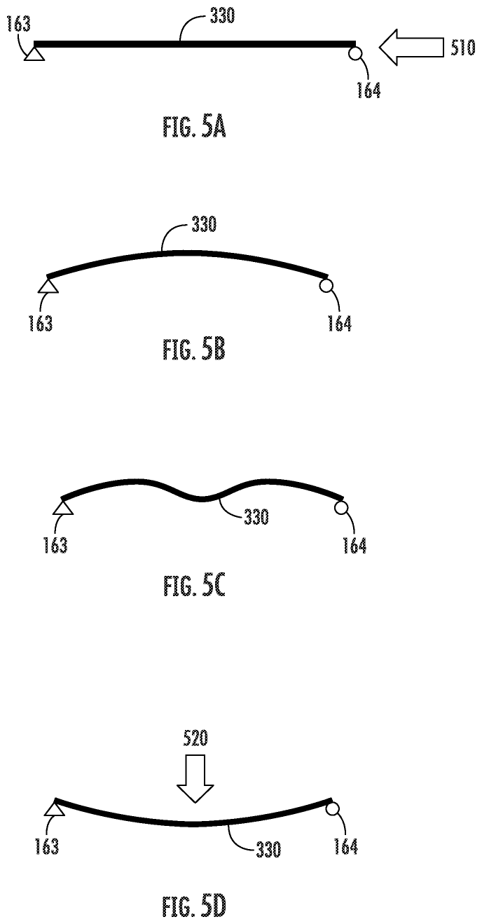

FIG. 6 is a schematic top view of a slot 330S of an RF filter device 165 (FIG. 3A) having resonators 320 on opposite sidewalls 322-1 and 322-2 of the slot 330S, according to embodiments of the present inventive concepts. In particular, the resonators 320 may include a plurality of first resonators 320-A in respective cavities 321-A in the sidewall 322-1 and a plurality of second resonators 320-B in respective cavities 321-B in the sidewall 322-2. The first resonators 320-A may be configured to provide a first filtering response that is different from a second filtering response that the second resonators 320-B are configured to provide. For example, the second filtering response may provide a wider passband than the first filtering response.

As shown in FIG. 6, a transmission line 330 that is in the slot 330S may be closer to the second resonators 320-B than to the first resonators 320-A. Moreover, an actuator 161 (FIG. 1C) may be configured to move the transmission line 330 to (and/or from) a different position at which the transmission line 330 is closer to the first resonators 320-A than to the second resonators 320-B. For example, the actuator 161 may be configured to move a dielectric rod 167 (FIG. 1C) that is coupled to the transmission line 330. In some embodiments, movement of the rod 167 may apply a mechanical force to the transmission line 330 and thereby bend springs 410 that are coupled to respective end portions of the transmission line 330, thus allowing the transmission line 330 to move without bending, as discussed herein with respect to FIGS. 4A and 4B. In other embodiments, movement of the rod 167 may bend the transmission line 330, as discussed herein with respect to FIGS. 5A-5D.

For simplicity of illustration, only one slot 330S is shown in FIG. 6. In some embodiments, however, the filter device 165 may include a plurality of (e.g., four, eight, or more) slots 330S, each of which has a respective transmission line 330 therein that is movable between two different groups of resonators 320 that are configured to provide first and second filtering responses, respectively.

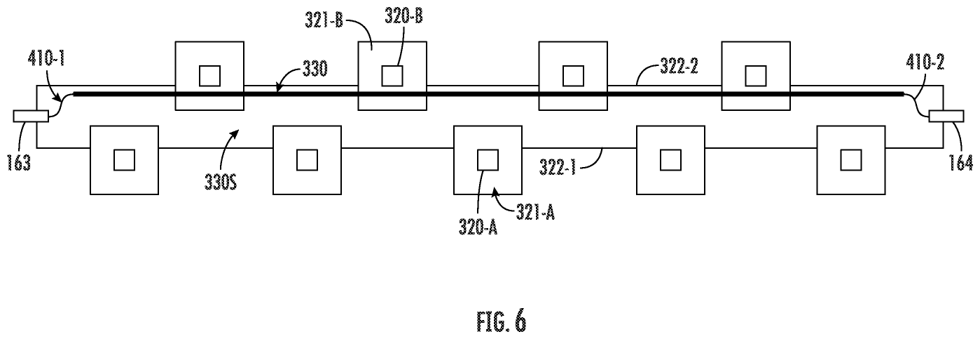

FIG. 7 is a flowchart illustrating operations of switching a filtering-response mode of an RF filter device 165 (FIG. 3A), according to embodiments of the present inventive concepts. The operations may include switching (Block 710) between first and second filtering-response modes of the filter device 165 by moving a movable RF transmission line 330 (FIG. 3A) of the filter device 165 between different respective positions. For example, the first filtering-response mode may be a mode in which the transmission line 330 has relatively strong electromagnetic coupling with a group of resonators 320. FIGS. 3A and 4A show examples of such electromagnetic coupling, which results from having a relatively short distance separating the transmission line 330 from the group of resonators 320. It is also shown with respect to resonators 320-B in FIG. 6. Conversely, the second filtering-response mode may be a mode in which the transmission line 330 has relatively weak electromagnetic coupling with the group of resonators 320, resulting from a relatively long distance that separates the transmission line 330 from the group of resonators 320. This is shown, for example, in FIGS. 3B and 4B. It is also shown with respect to resonators 320-A in FIG. 6. Accordingly, moving the transmission line 330 may comprise reducing electromagnetic coupling between the transmission line 330 and the group of resonators 320.

In some embodiments, the switching (Block 710) may be performed in response to receiving (Block 700) a signal that is used to remotely control the filter device 165. For example, the filter device 165, which may be internal or external to a base station antenna 100 (FIG. 1A), may filter uplink and/or downlink RF signals for the antenna 100 and may change its filtering response (e.g., to use a wider passband) based on the received signal. As an example, the received signal may comprise an AISG command that is transmitted to a port 162 (FIG. 1C) of the filter device 165 (e.g., via the antenna 100) from an original location/transmitter that is outside of the antenna 100.

Moving the transmission line 330 may include applying a mechanical force to the transmission line 330. Applying the force may, in some embodiments, include using an actuator 161 (FIG. 3A) to move a dielectric rod 167 (FIG. 3A) that is coupled to the transmission line 330. In some embodiments, moving the rod 167 may cause one or more springs 410 (FIG. 4A) to bend. In other embodiments, moving the rod 167 may bend the transmission line 330, as shown in FIGS. 5A-5D.

By bending (a) the spring(s) 410 or (b) the transmission line 330, the transmission line 330 may electromagnetically decouple from the group of resonators 320. Moreover, the transmission line 330 may, in some embodiments, increase its electromagnetic coupling with a different group of resonators (e.g., resonators 320-A of FIG. 6 versus resonators 320-B of FIG. 6). A different filtering response by the filter device 165 can thus be provided by changing a level of electromagnetic coupling of the transmission line 330 with one or more groups of resonators 320.

In some embodiments, the transmission line 330 may be one among a plurality of movable RF transmission lines 330-1 through 330-4 (FIG. 3A) that are inside a housing 310 (FIG. 3A) of the filter device 165. Moreover, the rod 167 may be attached to each of the transmission lines 330-1 through 330-4. Accordingly, the switching (Block 710) may comprise concurrently moving each of the transmission lines 330-1 through 330-4.

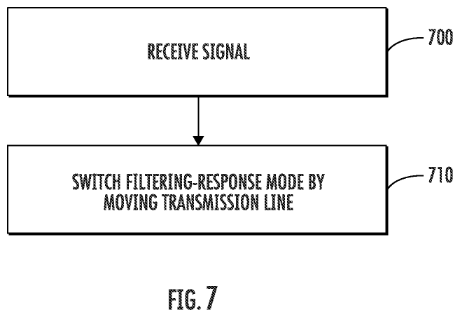

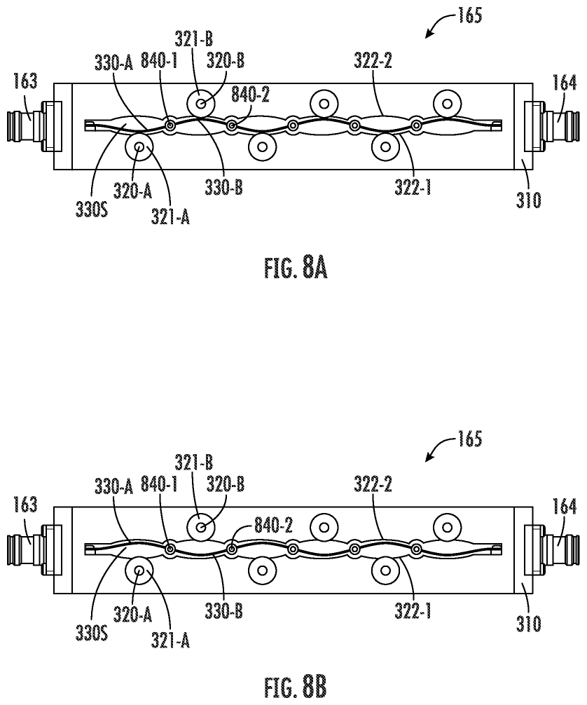

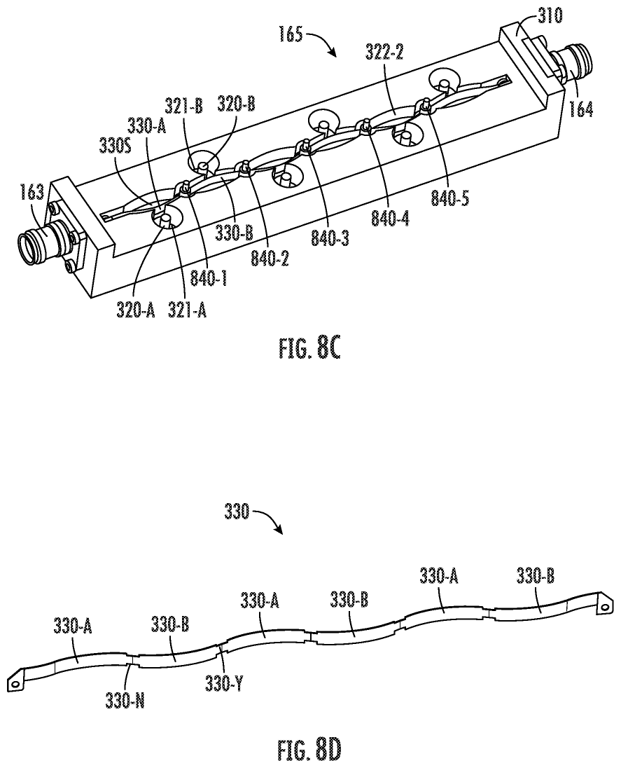

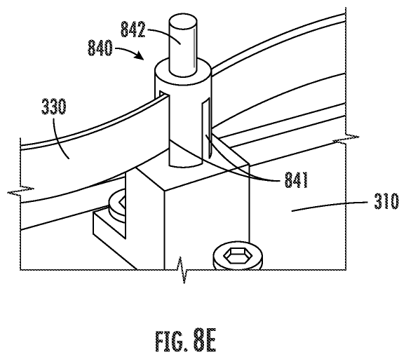

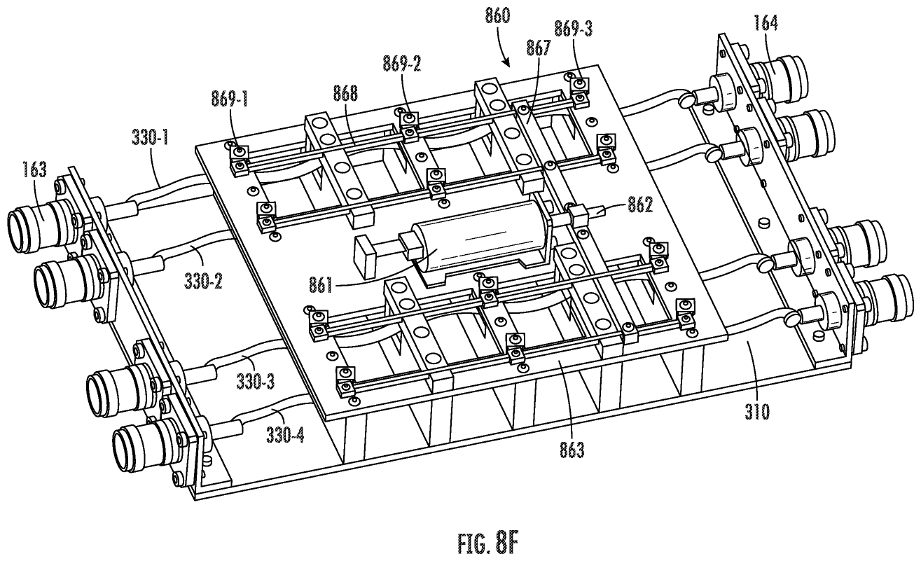

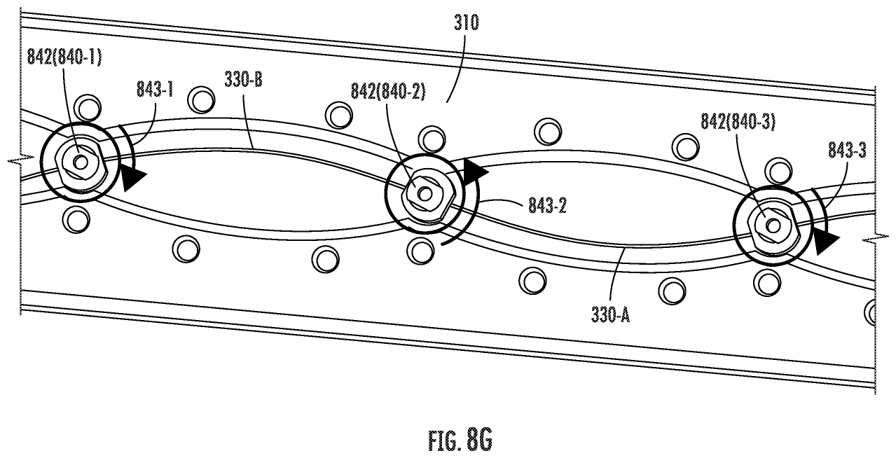

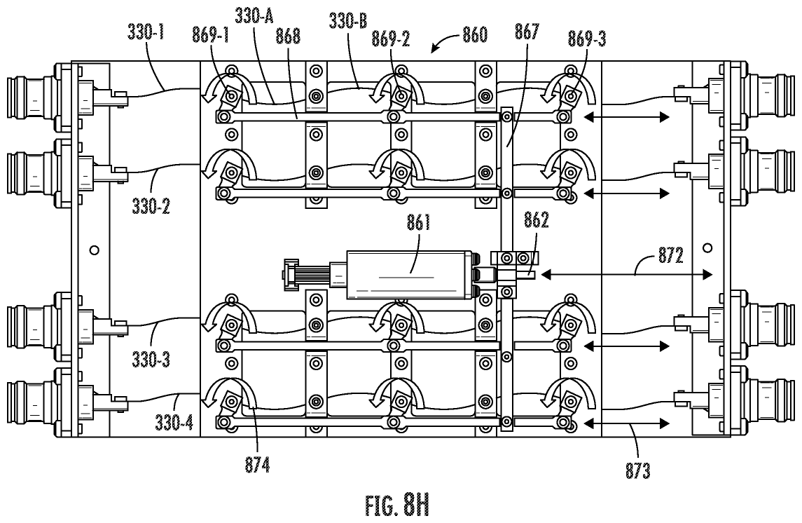

FIGS. 8A and 8B are top views, during respective filtering-response modes, of the inside of an RF filter device 165 including a movable RF transmission line 330 that has a plurality of arc portions 330-A and 330-B, according to embodiments of the present inventive concepts. In particular, the transmission line 330 may be a continuous, flexible transmission line in which each of the arc portions 330-A and 330-B is flexible. In a first filtering-response mode (FIG. 8A) of the filter device 165, the arc portions 330-A may be closer to a first interior sidewall 322-1 of a housing 310 of the filter device 165 than to a second interior sidewall 322-2 of the housing 310, whereas the arc portions 330-B may be closer to the second interior sidewall 322-2 than to the first interior sidewall 322-1. Moreover, in a second filtering-response mode (FIG. 8B) of the filter device 165, the arc portions 330-A may be closer to the second interior sidewall 322-2 and the arc portions 330-B may be closer to the first interior sidewall 322-1. The first and second filtering-response modes may be, for example, in-service and out-of-service modes, respectively, of the filter device 165.

The arc portions 330-A and 330-B may repeatedly alternate with each other such that the transmission line 330 has a generally sinusoidal shape. For example, as shown in FIGS. 8A and 8B, three arc portions 330-A may alternate with three arc portions 330-B. The transmission line 330 is not limited, however, to having three arc portions 330-A and three arc portions 330-B. Rather, the transmission line 330 may have one, two, four, or more arc portions 330-A and one, two, four, or more arc portions 330-B. In some embodiments, the arc portions 330-A may sequentially or concurrently move in the same, first direction (e.g., toward the first interior sidewall 322-1), while the arc portions 330-B may sequentially or concurrently move in the same, second direction (e.g., toward the second interior sidewall 322-2) that is opposite the first direction. Moreover, though a single sinusoidal transmission line 330 is shown in FIGS. 8A and 8B, the filter device 165 may include two, three, four, or more sinusoidal transmission lines 330.

To accommodate the arc portions 330-A and the arc portions 330-B, the interior sidewalls 322-1 and 322-2 may each have a plurality of curved portions. Moreover, a plurality of dielectric (e.g., plastic) supports 840 may be physically connected to (i.e., in direct contact with) respective regions of the transmission line 330. Specifically, the supports 840 may be at respective boundary regions 330-Y (FIG. 8D) between adjacent ones of the arc portions 330-A and 330-B. The supports 840 can help to maintain the mechanical stability (e.g., the generally sinusoidal shape) of the transmission line 330. In some embodiments, the supports 840 may be configured to rotate axially as the transmission line 330 switches between different positions. The supports 840 may also be configured to reduce/prevent lateral and vertical movement by transmission line 330 at the respective regions 330-Y where the transmission line 330 is connected to the supports 840. As an example, each support 840 may have an opening 841 (FIG. 8E) through which the transmission line 330 extends and at which a position of the transmission line 330 is fixed.

The transmission line 330 may, in some embodiments, have an asymmetrical shape. For example, one or more of the arc portions 330-A and 330-B may have a curvature (e.g., an amplitude) that is different from a curvature of others of the arc portions 330-A and 330-B. Moreover, the supports 840 may not be equidistant from each other along a longitudinal dimension of the transmission line 330. Rather, spacing between consecutive ones of the supports 840 can vary.

FIG. 8C is a top perspective view of the inside of the filter device 165 of FIG. 8A. Specifically, FIG. 8C shows locations of the arc portions 330-A and 330-B while the filter device 165 is in the first filtering-response mode. FIG. 8C also shows that the number of supports 840 (e.g., five supports 840-1 through 840-5) that are physically connected to the transmission line 330 may be one fewer than the total number of (e.g., six) arc portions 330-A and 330-B of the transmission line 330.

FIG. 8D is a side perspective view of the transmission line 330 of FIG. 8B. In particular, FIG. 8D shows that the transmission line 330 may include three arc portions 330-A that alternate with three arc portions 330-B. Boundary regions 330-Y of the transmission line 330 that are between the arc portions 330-A and 330-B may include one or more notches 330-N (e.g., cutout portions) that reduce a vertical thickness of the transmission line 330 at positions where it is configured to be held by supports 840 (FIG. 8C). In some embodiments, the transmission line 330 may be a stripline that has a horizontal thickness, in a direction in which the transmission line 330 moves to transition between the first and second filtering-response modes, between 0.05 mm and 0.8 mm, such as between 0.1 mm and 0.3 mm. For example, the horizontal thickness of the transmission line 330 may be about 0.2 mm.

FIG. 8E is a side perspective view of a support 840 of FIG. 8C. The support 840 may include one or more openings 841 (e.g., slots) through which the transmission line 330 can extend. Accordingly, an opening 841 may be configured to receive a respective portion of the transmission line 330. For example, a vertical thickness of the transmission line 330 may be narrowed by one or more notches 330-N (FIG. 8D) such that a vertically thin portion (e.g., a region 330-Y (FIG. 8D)) of the transmission line 330 can fit into an opening 841 of the support 840. Other portions of the transmission line 330, by contrast, may be vertically thicker than the opening 841, thus allowing the support 840 to restrict movement of the transmission line 330 along its longitudinal dimension.

In some embodiments, the support 840 may include a male, vertically-protruding portion 842. As an example, the male portion 842 may vertically protrude from a base portion of the support 840 that is mounted on a housing 310 of the filter device 165 (FIG. 8A).

FIG. 8F is a top perspective view of a system 860 that is configured to cause each of the arc portions 330-A and 330-B of FIG. 8D to move. For example, the system 860 may be configured to apply torque to supports 840 (FIG. 8C) to cause at least two of the arc portions 330-A and 330-B to move concurrently with each other. Because the arc portions 330-A and 330-B are attached to each other, movement of some of the arc portions 330-A and 330-B can result in movement of others of the arc portions 330-A and 330-B, even if the system 860 does not directly apply torque to each of the supports 840.

The system 860 includes an actuator 861 as well as rods 867 and 868 that are configured to be moved by the actuator 861. The system 860 also includes rotatable elements 869 having female portions on bottom sides thereof that are configured to receive respective male portions 842 (FIG. 8E) of the supports 840. As an example, bottom-side female portions of rotatable elements 869-1 through 869-3 may be configured to receive respective male portions 842 of non-consecutive supports 840-1, 840-3, and 840-5 (FIG. 8C). When the female portions of the rotatable elements 869 are physically engaged with the male portions 842 of the supports 840, movement of the system 860 can cause concurrent axial rotation of at least two (or at least three) of the supports 840. For example, the supports 840 that are engaged with the rotatable elements 869 may be non-consecutive supports 840 that are concurrently rotated clockwise or counterclockwise, while others of the supports 840 may not be engaged with the rotatable elements 869 and thus may rotate in an opposite direction in response to the rotation of the engaged supports 840. This collective rotation of the supports 840 results in a bending of a transmission line 330 such that a shape of each of its arc portions 330-A and 330-B inverts. Moreover, in some embodiments, the system 860 may be configured to concurrently invert each of the arc portions 330-A and 330-B of each of a plurality of transmission lines 330 (e.g., each of the four transmission lines 330-1 through 330-4).

The system 860 is thus configured to switch between the two filtering-response modes that are shown in FIGS. 8A and 8B by directly or indirectly rotating the supports 840. Accordingly, the supports 840 may be configured to both (i) maintain a sinusoidal shape of a transmission line 330 when the system 860 is not applying torque and (ii) function as switching elements that can invert the sinusoidal shape in response to torque from the system 860.

In some embodiments, the system 860 may include a cover 863 (e.g., a conductive plate) that extends over portions of each of the transmission lines 330-1 through 330-4. The actuator 861 may be mounted on top of the cover 863. Moreover, the male portions 842 of the supports 840 may protrude through openings of the cover 863 to engage with the rotatable elements 869 that are controlled by the actuator 861.

Movement of the system 860, and thereby movement of the supports 840 and the arc portions 330-A and 330-B, is controlled by the actuator 861, which may be an electric motor, such as a stepper motor. For example, the actuator 861 may be configured to rotate a shaft 862. In some embodiments, the shaft 862 may be a stainless steel part that is mounted directly on a shaft of the actuator 861. In other embodiments, the shaft 862 may be the direct shaft of the actuator 861. Moreover, the shaft 862 may be a threaded shaft to which the rod 867 is attached.

The rod 867 may be a single rod that is configured to concurrently move a plurality of rods 868. For example, the rods 868 may extend longitudinally in a direction that is perpendicular to a direction in which the rod 867 extends longitudinally. As an example, each of the rods 868 may be configured to move the sinusoidal shape (i.e., the arc portions 330-A and 330-B) of a respective transmission line 330. The rod 867 and the rods 868 may, in some embodiments, be dielectric rods.

Because the supports 840 can maintain the sinusoidal shape of a transmission line 330, additional supports (e.g., spacers) that control a distance between the transmission line 330 and the interior sidewalls 322-1 and 322-2 may be omitted. The supports 840 and the arc portions 330-A and 330-B whose movements are controlled thereby can thus facilitate a mechanically solid design that does not require additional supports for the transmission line 330.

FIG. 8G is a top view of some of the supports 840 of FIG. 8C. In particular, FIG. 8G shows that the supports 840 can be axially rotated either clockwise or counterclockwise. For example, female portions of rotatable elements 869 of the system 860 of FIG. 8F may be respectively attached to (and thus configured to directly apply torque to) only non-consecutive male portions 842 of the supports 840. As an example, by attaching the female portions to the male portions 842 of the supports 840-1 and 840-3 (but not the support 840-2) and moving the rotatable elements 869, positions of the arc portions 330-A and 330-B can be inverted in response to clockwise rotations 843-1 and 843-3 of the supports 840-1 and 840-3, respectively, about their vertical axes and a counterclockwise rotation 843-2 of the support 840-2 has about its vertical axis. This inversion of a transmission line 330 can then be reversed by moving the rotatable elements 869 (e.g., in a movement opposite that which caused the inversion) to rotate the supports 840-1 and 840-3 in the opposite (i.e., counterclockwise) direction of what is shown in FIG. 8G and to rotate the support 840-2 in the opposite (i.e., clockwise) direction of what is shown in FIG. 8G.

In some embodiments, a sinusoidal shape of a transmission line 330 may be fully inverted (i.e., all of the arc portions 330-A and 330-B may be inverted) without concurrently rotating all of the supports 840 via the rotatable elements 869. For example, assuming no friction and no other mechanical losses, directly applying torque to only one of the supports 840 may be sufficient to cause all of the arc portions 330-A and 330-B of a transmission line 330 to sequentially switch between the positions that are shown in FIGS. 8A and 8B. To account for friction and/or mechanical losses, however, torque may be directly applied by the rotatable elements 869 to more than one support 840. Specifically, to ensure complete inversion of the sinusoidal shape of the transmission line 330, the rotatable elements 869 may directly apply torque via female portions thereof to at least two (or at least three) non-consecutive supports 840, such as the supports 840-1 and 840-3 that rotate in the same direction.

All of the supports 840 can rotate freely while also being attached to a transmission line 330. Though the rotatable elements 869 may be attached only to non-consecutive supports 840 (including the supports 840-1 and 840-3), the support 840-2 (as well as any other support that is not attached to the rotatable elements 869) remains free to rotate in response to rotation of the transmission line 330. Such rotation may be referred to herein as being “indirectly” caused by the rotatable elements 869 because the rotatable elements 869 do not directly contact and apply torque to the support 840-2. Accordingly, the rotatable elements 869 of the system 860 may, in some embodiments, be configured to switch between the two filtering-response modes that are shown in FIGS. 8A and 8B by directly rotating some (or all) of the supports 840.

In other embodiments, the switching may be performed by pushing/pulling a transmission line 330 at all (or at only non-consecutive ones) of its arc portions 330-A and 330-B. For example, instead of attaching the rotatable elements 869 to the supports 840, one or more rods 167/867 (FIGS. 3A and 8F) may be physically connected to, and configured to push/pull, some (or all) of the arc portions 330-A and 330-B. In such embodiments, the rotatable elements 869 may be omitted.

FIG. 8H is a top view of the system 860 of FIG. 8F. As shown in FIG. 8H, the actuator 861 can cause a lateral movement 872 (e.g., a push or a pull) of the rod 867 by rotating the shaft 862. The lateral movement 872 may cause concurrent lateral movements 873 of the rods 868, and the lateral movements 873 may result in axial rotations 874 of the rotatable elements 869. For example, the axial rotations 874 may be counterclockwise rotations, as shown in FIG. 8H, or may be clockwise rotations, depending on the direction (e.g., a push direction or a pull direction) of the lateral movements 872 and 873.

RF filter devices 165 (FIGS. 1C and 1D) having a movable RF transmission line 330 (FIGS. 3A-6, 8A-8H) according to embodiments of the present inventive concepts may provide a number of advantages. These advantages include remotely changing filtering responses of the filter devices 165, such as by using AISG commands, rather than requiring technicians to manually change the filtering responses, such as by physically accessing antennas and/or antenna towers having the filter devices 165. For example, a filter device 165 may include an actuator 161 (FIGS. 1C and 1D) that is configured to move the transmission line 330 between (i) a first position at which the transmission line 330 is electromagnetically coupled to a plurality of resonators 320 (FIG. 3A) that are inside a housing 310 (FIG. 3A) of the filter device 165 and (ii) a second position at which the transmission line 330 is electromagnetically decoupled from the resonators 320. Specifically, the transmission line 330 is farther from the resonators 320 when it is at the second position than when it is at the first position.

Moreover, whereas mechanical contacts of electromechanical switches can cause PIM distortion, the actuator 161 may be a solenoid or an electric motor, rather than an electromechanical switch, and thus may reduce PIM distortion. For example, the actuator 161 may push or pull the transmission line 330 by moving a dielectric rod 167 (FIG. 3A) that is coupled to the transmission line 330. The actuator 161 may provide reduced insertion loss, reduced size, and/or reduced cost relative to electromechanical switches. As an example, insertion loss for the filter device 165 for frequencies between 3.7 GHz and 3.8 GHz may be less than 1 dB for an in-service mode and less than 0.3 dB for an out-of-service mode.

A single actuator 161 may be coupled to a plurality of transmission lines 330 and thus may concurrently move all of the transmission lines 330 to switch between different filtering-response modes. For example, the dielectric rod 167 may be coupled between the transmission lines 330 and the actuator 161, thereby facilitating synchronous switching of the transmission lines 330 to different positions that provide different filtering responses.

The present inventive concepts have been described above with reference to the accompanying drawings. The present inventive concepts are not limited to the illustrated embodiments. Rather, these embodiments are intended to fully and completely disclose the present inventive concepts to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present inventive concepts. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A filter device comprising:
a housing;
a plurality of resonators that are inside the housing;
a radio frequency (RF) signal input and an RF signal output;
a movable RF transmission line that is coupled between the RF signal input and the RF signal output; and
an actuator that is configured to move the movable RF transmission line between a first position that is inside the housing and a second position that is inside the housing,
wherein the resonators are electromagnetically coupled to the movable RF transmission line when the movable RF transmission line is at the first position and are electromagnetically decoupled from the movable RF transmission line when the movable RF transmission line is at the second position.

2. The filter device of claim 1,
wherein the movable RF transmission line comprises a first movable RF transmission line,
wherein the resonators comprise first resonators, and
wherein the filter device further comprises:
a plurality of second resonators that are inside the housing; and
a second movable RF transmission line that is configured to move between a third position at which the second movable RF transmission line is electromagnetically coupled to the second resonators and a fourth position at which the second movable RF transmission line is electromagnetically decoupled from the second resonators.

3. The filter device of claim 2, further comprising:
a plurality of third resonators that are inside the housing;
a third movable RF transmission line that is configured to move between a fifth position at which the third movable RF transmission line is electromagnetically coupled to the third resonators and a sixth position at which the third movable RF transmission line is electromagnetically decoupled from the third resonators;
a plurality of fourth resonators that are inside the housing; and
a fourth movable RF transmission line that is configured to move between a seventh position at which the fourth movable RF transmission line is electromagnetically coupled to the fourth resonators and an eighth position at which the fourth movable RF transmission line is electromagnetically decoupled from the fourth resonators.

4. The filter device of claim 3, further comprising a dielectric rod that is coupled between the actuator and each of the first through fourth movable RF transmission lines.

5. The filter device of claim 4, further comprising a spring that is coupled between the dielectric rod and the actuator, wherein the actuator comprises a solenoid or an electric motor.

6. The filter device of claim 3, wherein the first through fourth movable RF transmission lines are in first through fourth slots, respectively, of the housing.

7. The filter device of claim 1,
wherein the movable RF transmission line is between opposite first and second interior sidewalls of the housing, and
wherein the resonators are in respective cavities in the first interior sidewall.

8. The filter device of claim 7,
wherein the resonators comprise first resonators that are configured to provide a first filtering response,
wherein the filter device further comprises a plurality of second resonators that are configured to provide a second filtering response that is different from the first filtering response, and
wherein the second resonators are in respective cavities in the second interior sidewall.

9. The filter device of claim 1, wherein the actuator is configured to move the movable RF transmission line between the first position and the second position by bending the movable RF transmission line.

10. The filter device of claim 1, further comprising a spring that is coupled to an end portion of the movable RF transmission line,
wherein the actuator is configured to move the movable RF transmission line between the first position and the second position by applying a mechanical force to the movable RF transmission line that bends the spring.

11. The filter device of claim 1,
wherein the resonators comprise first resonators that are configured to provide a first filtering response,
wherein the filter device further comprises a plurality of second resonators that are configured to provide a second filtering response that is different from the first filtering response, and
wherein the movable RF transmission line is closer to the first resonators than the second resonators at the first position and is closer to the second resonators than the first resonators at the second position.

12. The filter device of claim 1, wherein the actuator comprises a remotely-controllable actuator.

13. The filter device of claim 12, further comprising a port that is coupled to the remotely-controllable actuator,
wherein the port and the remotely-controllable actuator comprise a remote electrical tilt (RET) port and a RET actuator, respectively.

14. The filter device of claim 1,
wherein the filter device is configured to operate in a first filtering-response mode when the movable RF transmission line is at the first position and to operate in a second filtering-response mode when the movable RF transmission line is at the second position, and
wherein the second filtering-response mode has a wider passband than the first filtering-response mode.

15. The filter device of claim 1, wherein the movable RF transmission line comprises a bi-stable transmission line.

16. A filter device comprising:
a plurality of resonators;
first and second radio frequency (RF) ports;
a movable RF transmission line that is coupled between the first RF port and the second RF port; and
an actuator that is configured to move the movable RF transmission line between a first position at which the movable RF transmission line is electromagnetically coupled to the resonators and a second position at which the movable RF transmission line is electromagnetically decoupled from the resonators.

17. The filter device of claim 16, further comprising a spring-loaded rod that is coupled between the actuator and the movable RF transmission line.

18. A filter device comprising:
a plurality of resonators; and
a movable radio frequency (RF) transmission line that is configured to move between a first position and a second position relative to the resonators, wherein electromagnetic coupling between the movable RF transmission line and the resonators is reduced at the second position relative to the first position.

19. (canceled)

20. The filter device of claim 18,
wherein the movable RF transmission line comprises a first of a plurality of movable RF transmission lines, and
wherein the filter device further comprises a dielectric rod that is coupled to, and configured to concurrently move, each of the movable RF transmission lines.

21. The filter device of claim 18, wherein the movable RF transmission line comprises a plurality of flexible arc portions that are each configured to invert.

22.-36. (canceled)
